(19) United States
(12) Patent Application Publication
(10) Pub. No.: US 2021/0103346 A1
(43) Pub. Date: Apr. 8, 2021

(54) WRITING FEEL IMPROVING SHEET

(71) Applicant: LINTEC CORPORATION, Tokyo (JP)

(72) Inventor: Hiroki HOSHINO, Tokyo (JP)

(73) Assignee: LINTEC CORPORATION, Tokyo (JP)

(21) Appl. No.: 17/060,669

(22) Filed: Oct. 1, 2020

(30) Foreign Application Priority Data
Oct. 4, 2019 (JP) 2019-183520

(51) Int. Cl. G06F 3/039

(52) U.S. Cl. CPC G06F 3/0393

(57) ABSTRACT

A writing feel improving sheet having a touch pen contact surface with which a touch pen comes into contact, the writing feel improving sheet having a dynamic friction coefficient as measured when a touch pen is linearly slid on the touch pen contact surface at a predetermined sliding speed, wherein the dynamic friction coefficient when the sliding speed is 1.5 mm/s is 0.13 or more and 0.35 or less, the dynamic friction coefficient when the sliding speed is 20 mm/s is 0.15 or more and 0.40 or less, the dynamic friction coefficient when the sliding speed is 50 mm/s is 0.18 or more and 0.45 or less, and the dynamic friction coefficient when the sliding speed is 80 mm/s is 0.18 or more and 0.47 or less.

### TECHNICAL FIELD

The present invention relates to a writing feel improving sheet that can improve the writing feel with a touch pen on a touch panel or the like.

### BACKGROUND ART

In recent years, image display devices (touch panels) having a position detection function and serving both as a display device and as an input means are widely used in various electronic devices. Such touch panels include those in which the input operation is performed by a finger as well as those in which the input operation is performed using a touch pen. The touch pen allows the input operation to be performed with a higher degree of accuracy than by a finger. Usually, however, display modules of touch panels are rigid. The writing feel with a touch pen is therefore different from the writing feel when writing on paper with a pen or pencil and cannot be said to be good.

To solve the problem of writing feel with a touch pen on a touch panel, it has been considered to attach a sheet for improving the writing feel (which may be referred to as a “writing feel improving sheet,” hereinafter) to the outermost surface of the touch panel. For example, Patent Documents 1 and 2 disclose writing feel improving sheets configured such that a friction coefficient when writing on the surface of a film with a touch pen is adjusted to fall within a predetermined range. In particular, Patent Document 1 discloses defining the relationship between the static friction coefficient and the dynamic friction coefficient when moving a touch pen at a speed of 5 cm/s. On the other hand, Patent Document 2 discloses defining the relationship between the static friction coefficient and the dynamic friction coefficient when moving a touch pen at a speed of 100 mm/s.

### PRIOR ART DOCUMENTS

### Patent Documents

[Patent Document 1] JP6156647B

[Patent Document 2] JP5774954A

### SUMMARY OF THE INVENTION

### Problems to be Solved by the Invention

According to the inventions disclosed in Patent Document 1 and Patent Document 2, however, the writing feel when writing on paper with a pen or pencil (in particular, a ballpoint pen) was not sufficiently obtained. Thus, there is a demand for the development of a writing feel improving sheet that further well reproduces the writing feel when writing on paper with a pen or pencil.

The present invention has been made in consideration of such actual circumstances and an object of the present invention is to provide a writing feel improving sheet that can well reproduce the writing feel when writing on paper with a pen or pencil.

### Means for Solving the Problems

To achieve the above object, first, the present invention provides a writing feel improving sheet having a touch pen contact surface with which a touch pen comes into contact, the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein the dynamic friction coefficient when the sliding speed is 1.5 mm/s is 0.13 or more and 0.35 or less, the dynamic friction coefficient when the sliding speed is 20 mm/s is 0.15 or more and 0.40 or less, the dynamic friction coefficient when the sliding speed is 50 mm/s is 0.18 or more and 0.45 or less, and the dynamic friction coefficient when the sliding speed is 80 mm/s is 0.18 or more and 0.47 or less (Invention 1).

The dynamic friction coefficients as measured at the above-described four sliding speeds fall within the above-described respective ranges, and the writing feel improving sheet according to the above invention (Invention 1) can thereby well reproduce the feeling of vibration on paper when writing on the paper with a pen or pencil (in particular, a ballpoint pen) at various writing speeds. This allows the writing feel when writing on paper with a pen or pencil to be reproduced well.

Second, the present invention provides a writing feel improving sheet having a touch pen contact surface with which a touch pen comes into contact, the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein when measurement results are plotted on a coordinate plane with the sliding speed as a horizontal axis (unit: mm/s) and the dynamic friction coefficient as a vertical axis, an inclination of a line segment connecting between coordinates at which the sliding speed is 1.5 mm/s and coordinates at which the sliding speed is 50 mm/s is more than 0.0006 and less than 0.0072 Invention 2).

The above-described inclination falls within the above range, and the writing feel improving sheet according to the above invention (Invention 2) can thereby well reproduce the feeling of vibration on paper when writing on the paper with a pen or pencil (in particular, a ballpoint pen) at various writing speeds. This allows the writing feel when writing on paper with a pen or pencil to be reproduced well.

Third, the present invention provides a writing feel improving sheet having a touch pen contact surface with which a touch pen comes into contact, the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein when measurement results are plotted on a coordinate plane with the sliding speed as a horizontal axis (X-axis) (unit: mm/s) and the dynamic friction coefficient as a vertical axis (Y-axis), an approximation curve obtained by polynomial approximation of four sets of coordinates: coordinates at which the sliding speed is 1.5 mm/s; coordinates at which the sliding speed is 20 mm/s; coordinates at which the sliding speed is 50 mm/s; and coordinates at which the sliding speed is 80 mm/s satisfies the following expressions (1) to (4):

Y=aX²+bX+c (1),

−5×10⁻⁵≤a≤−5×10⁻⁶ (2),

0.0001≤b≤0.008 (3), and

0.11≤c≤0.31≤ (4) (Invention 3).

The writing feel improving sheet according to the above invention (Invention 3) exhibits the above-described approximation curve and can thereby well reproduce the feeling of vibration on paper when writing on the paper with a pen or pencil (in particular, a ballpoint pen) at various writing speeds. This allows the writing feel when writing on paper with a pen or pencil to be reproduced well.

In the above invention (Invention 1 to 3), the writing feel improving sheet may preferably comprise: a writing feel improving layer; and a base provided on one surface side of the writing feel improving layer, wherein the touch pen contact surface may preferably be a surface of the writing feel improving layer opposite to the base (Invention 4).

### Advantageous Effect of the Invention

The writing feel improving sheet according to the present invention can well reproduce the writing feel when writing on paper with a pen or pencil.

### EMBODIMENTS FOR CARRYING OUT THE INVENTION

Hereinafter, one or more embodiments of the present invention will be described.

The writing feel improving sheet according to an embodiment of the present invention has a touch pen contact surface with which a touch pen comes into contact. Both surfaces of the writing feel improving sheet according to the present embodiment may be the touch pen contact surfaces, but usually one surface of the writing feel improving sheet may be the touch pen contact surface and the other surface may be a surface for being attached to a touch panel or the like.

### 1. Physical Properties of Writing Feel Improving Sheet

### (1) Dynamic Friction Coefficient

The writing feel improving sheet according to the present embodiment may preferably satisfy the following condition for the dynamic friction coefficient as measured when, after the pen tip having a diameter of 0.5 mm of a touch pen is brought into contact with the touch pen contact surface of the writing feel improving sheet, a load of 200 g is applied to the above touch pen and the above touch pen is linearly slid at a predetermined sliding speed while maintaining an angle formed between the above touch pen and the above touch pen contact surface at 45°. That is, it is preferred that the dynamic friction coefficient when the above sliding speed is 1.5 mm/s should be 0.13 or more and 0.35 or less, the dynamic friction coefficient when the above sliding speed is 20 mm/s should be 0.15 or more and 0.40 or less, the dynamic friction coefficient when the above sliding speed is 50 mm/s should be 0.18 or more and 0.45 or less, and the dynamic friction coefficient when the above sliding speed is 80 mm/s should be 0.18 or more and 0.47 or less.

Upon the study of the writing feel, the present inventor focused attention on the fact that the writing speed when writing on paper with a pen or pencil varies depending on the writer and the content to be written. For example, the writing speed tends to be relatively fast when a memo is simply taken, while the writing speed tends to be relatively slow when performing “kanji” writing learning. As a result of further detailed study, the present inventor has discovered that the dynamic friction coefficient when writing on paper with a pen or pencil varies depending on the writing speed. It has been found that when writing on paper with a ballpoint pen, for example, the slower the writing speed, the smaller the dynamic friction coefficient tends to be, and the faster the writing speed, the larger the dynamic friction coefficient tends to be. In the conventional writing feel improving sheets, it cannot be said that such variation of the dynamic friction coefficient depending on the writing speed is sufficiently reproduced.

On the other hand, the writing feel improving sheet according to the present embodiment satisfies the above-described dynamic friction coefficient for each of the above-described four sliding speeds; therefore, upon the use of a touch pen on a touch panel to which the writing feel improving sheet is attached, the feeling of vibration transmitted to the hand holding the touch pen is very close to the feeling of vibration obtained when writing on paper with a pen or pencil (in particular, a ballpoint pen). In particular, in the writing feel improving sheet according to the present embodiment, the variation of the dynamic friction coefficient depending on the writing speed is well reproduced. As a result, the writing feel improving sheet according to the present embodiment can achieve excellent writing feel more than ever before.

From the viewpoint of achieving more excellent writing feel, the dynamic friction coefficient when the sliding speed is 1.5 mm/s may be preferably 0.17 or more and particularly preferably 0.20 or more. In addition, the above dynamic friction coefficient may be preferably 0.30 or less and particularly preferably 0.29 or less.

From the same viewpoint, the dynamic friction coefficient when the sliding speed is 20 mm/s may be preferably 0.20 or more and particularly preferably 0.25 or more. In addition, the above dynamic friction coefficient may be preferably 0.36 or less and particularly preferably 0.33 or less.

From the same viewpoint, the dynamic friction coefficient when the sliding speed is 50 mm/s may be preferably 0.25 or more and particularly preferably 0.30 or more. In addition, the above dynamic friction coefficient may be preferably 0.40 or less and particularly preferably 0.37 or less.

From the same viewpoint, the dynamic friction coefficient when the sliding speed is 80 mm/s may be preferably 0.25 or more and particularly preferably 0.30 or more. In addition, the above dynamic friction coefficient may be preferably 0.40 or less and particularly preferably 0.37 or less.

Details of the method of measuring the above-described dynamic friction coefficient are as described in the testing example, which will be described later.

### (2) Inclination Relating to Dynamic Friction Coefficient

In the writing feel improving sheet according to the present embodiment, it is also preferred that the dynamic friction coefficient measured as described above should satisfy the following condition for an “inclination.”

That is, for the dynamic friction coefficient as measured when, after the pen tip having a diameter of 0.5 mm of a touch pen is brought into contact with the touch pen contact surface of the writing feel improving sheet according to the present embodiment, a load of 200 g is applied to the above touch pen and the above touch pen is linearly slid at a predetermined sliding speed while maintaining an angle formed between the above touch pen and the above touch pen contact surface at 45°, when the measurement results are plotted on a coordinate plane with the above sliding speed as a horizontal axis (unit: mm/s) and the above dynamic friction coefficient as a vertical axis, it is also preferred that the inclination of a line segment connecting between coordinates at which the above sliding speed is 1.5 mm/s and coordinates at which the above sliding speed is 50 mm/s should be more than 0.0006 and less than 0.0072.

In general, the sliding speed of 1.5 mm/s corresponds to a writing speed when writing at a considerably slow speed while the sliding speed of 50 mm/s corresponds to a writing speed when writing at a fast speed. In the writing feel improving sheet according to the present embodiment, when the above-described inclination falls within the above range, the dynamic friction coefficient increases as the sliding speed changes from a low speed to a high speed. This allows the relationship to be well reproduced between the writing speed and the dynamic friction coefficient when writing on paper with a pen or pencil in a general manner (i.e., the relationship can be reproduced in which the dynamic friction coefficient decreases when writing at a slow speed while the dynamic friction coefficient increases when writing at a fast speed), and it is possible to achieve excellent writing feel more than ever before.

From the viewpoint of achieving more excellent writing feel, the above-described inclination may be preferably 0.0008 or more, more preferably 0.0010 or more, particularly preferably 0.0011 or more, and further preferably 0.0013 or more. From the same viewpoint, the above-described inclination may be preferably 0.0050 or less, more preferably 0.0030 or less, particularly preferably 0.0026 or less, and further preferably 0.0020 or less.

When the line segment connecting between the coordinates at which the sliding speed is 1.5 mm/s and the coordinates at which the sliding speed is 50 mm/s is expressed by a linear expression, the intercept of the linear expression may be preferably 0.10 or more, particularly 0.16 or more, and further preferably 0.20 or more. In addition, the above intercept may be preferably 0.35 or less, particularly preferably 0.30 or less, and further preferably 0.28 or less. When the above intercept falls within the above-described range, the feeling of vibration from a pen or pencil when writing on paper with the pen or pencil can be more readily reproduced.

From the viewpoint of easy adjustment within the above-described range of the inclination of the line segment connecting between the coordinates at which the sliding speed is 1.5 mm/s and the coordinates at which the sliding speed is 50 mm/s, the inclination of the line segment connecting between the coordinates at which the sliding speed is 1.5 mm/s and the coordinates at which the above sliding speed is 20 mm/s may be preferably 0.0010 or more, particularly preferably 0.0013 or more, and further preferably 0.0018 or more on the coordinate plane obtained as above. From the same viewpoint, the inclination of the line segment connecting between the coordinates at which the sliding speed is 1.5 mm/s and the coordinates at which the sliding speed is 20 mm/s may be preferably 0.0090 or less, particularly preferably 0.0050 or less, and further preferably 0.0040 or less.

Also from the viewpoint of easy adjustment within the above-described range of the inclination of the line segment connecting between the coordinates at which the sliding speed is 1.5 mm/s and the coordinates at which the sliding speed is 50 mm/s, the inclination of the line segment connecting between the coordinates at which the sliding speed is 1.5 mm/s and the coordinates at which the above sliding speed is 80 mm/s may be preferably 0.0005 or more, particularly preferably 0.0007 or more, and further preferably 0.0009 or more on the coordinate plane obtained as above. From the same viewpoint, the inclination of the line segment connecting between the coordinates at which the sliding speed is 1.5 mm/s and the coordinates at which the sliding speed is 80 mm/s may be preferably 0.0030 or less, particularly preferably 0.0020 or less, and further preferably 0.0015 or less.

### (3) Approximation Curve Relating to Dynamic Friction Coefficient

In the writing feel improving sheet according to the present embodiment, it is also preferred that the dynamic friction coefficient measured as described above should satisfy the following condition for an “approximation curve.”

That is, for the dynamic friction coefficient as measured when, after the pen tip having a diameter of 0.5 mm of a touch pen is brought into contact with the touch pen contact surface of the writing feel improving sheet according to the present embodiment, a load of 200 g is applied to the above touch pen and the above touch pen is linearly slid at a predetermined sliding speed while maintaining an angle formed between the above touch pen and the above touch pen contact surface at 45°, when the measurement results are plotted on a coordinate plane with the above sliding speed as a horizontal axis (X-axis) (unit: mm/s) and the above dynamic friction coefficient as a vertical axis (Y-axis), it is also preferred that the approximation curve obtained by polynomial approximation of four sets of coordinates: coordinates at which the above sliding speed is 1.5 mm/s; coordinates at which the above sliding speed is 20 mm/s; coordinates at which the above sliding speed is 50 mm/s; and coordinates at which the above sliding speed is 80 mm/s should satisfy the following expressions (1) to (4):

Y=aX²+bX+c (1),

−5×10⁻⁵≤a≤−5×10⁻⁶ (2),

0.0001≤b≤0.008 (3), and

0.11≤c≤0.31 (4).

When the writing feel improving sheet according to the present embodiment exhibits the above-described approximation curve, the variation of the dynamic friction coefficient with respect to the variation of the sliding speed can readily match that when writing on paper with a pen or pencil. This allows the relationship to be well reproduced between the writing speed and the dynamic friction coefficient when writing on paper with a pen or pencil, and it is possible to achieve excellent writing feel more than ever before.

From such a viewpoint, the value of “a” in the above expression (2) may be preferably −4×10⁻⁵ or more and particularly preferably −3×10⁻⁵ or more. In addition, the value of “a” in the above expression (2) may be preferably −8×10⁻⁶ or less and particularly preferably −1×10⁻⁵ or less.

From the same viewpoint, the value of “b” in the above expression (3) may be preferably 0.0010 or more and particularly preferably 0.0020 or more. In addition, the value of “b” in the above expression (3) may be preferably 0.0050 or less and particularly preferably 0.0035 or less.

From the same viewpoint, the value of “c” in the above expression (4) may be preferably 0.16 or more and particularly preferably 0.20 or more. In addition, the value of “c” in the above expression (4) may be preferably 0.29 or less and particularly preferably 0.28 or less.

### (4) Optical Properties

The haze value of the writing feel improving sheet according to the present embodiment is not particularly limited and may be preferably 0.1% or more and more preferably 0.5% or more. From the viewpoint of obtaining sufficient antiglare properties, the haze value may be particularly preferably 10% or more. On the other hand, the above haze value may be preferably 95% or less, particularly preferably 50% or less, and further preferably 20% or less. When the above haze value is 95% or less, the writing feel improving sheet according to the present embodiment has higher transparency. The above haze value is measured in accordance with JIS K7136:2000, and the detailed measuring method is as described in the testing example, which will be described later.

The total luminous transmittance of the writing feel improving sheet according to the present embodiment may be preferably 70% or more, particularly preferably 80% or more, and further preferably 88% or more. When the above total luminous transmittance is 70% or more, the writing feel improving sheet according to the present embodiment has higher transparency. On the other hand, the upper limit of the above total luminous transmittance is not particularly limited and may be, for example, preferably 100% or less, particularly preferably 96% or less, and further preferably 92% or less. The above total luminous transmittance is measured in accordance with JIS K7361-1:1997, and the detailed measuring method is as described in the testing example, which will be described later.

### (5) Scratch Resistance

In the writing feel improving sheet according to the present embodiment, when the touch pen contact surface is rubbed at a load of 250 g/cm² using #0000 steel wool to reciprocate it ten times within a length of 10 cm, the number of scratches generated may be preferably 10 or less, particularly preferably 5 or less, and further preferably 0. This allows the touch pen contact surface of the writing feel improving sheet according to the present embodiment to exhibit good hard coat properties and excellent scratch resistance. The scratch resistance based on such evaluation of the hardness with the steel wool may readily be achieved when the writing feel improving sheet according to the present embodiment includes a hard coat layer as a writing feel improving layer as described later. The detailed method of measuring the above scratch resistance is as described in the testing example, which will be described later.

### 2. Layer Structure of Writing Feel Improving Sheet

The layer structure of the writing feel improving sheet according to the present embodiment is not particularly limited, provided that it satisfies the dynamic friction coefficient for each of the previously described sliding speeds and is applicable to a touch panel on which a touch pen is used.

From the viewpoint of readily achieving the dynamic friction coefficient for each of the previously described sliding speeds and easily adjusting other physical properties, the writing feel improving sheet according to the present embodiment may preferably include a writing feel improving layer and a base provided on one surface side of the writing feel improving layer. When this layer structure is employed, the touch pen contact surface may preferably be the surface of the writing feel improving layer opposite to the base.

### (1) Base

The above base can be appropriately selected from those suitable for a touch panel on which a touch pen is used. For example, a plastic film, a glass plate, or the like can be used as the above base, but it may be preferred to use a plastic film from the viewpoint of good affinity with the writing feel improving layer.

Examples of such a plastic film include films of polyesters such as polyethylene terephthalate, polybutylene terephthalate and polyethylene naphthalate, polyolefin films such as a polyethylene film and a polypropylene film, cellophane, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a fluorine resin film, a polyamide film, an acrylic resin film, a polyurethane resin film, a norbornene-based polymer film, a cyclic olefin-based polymer film, a cyclic conjugated diene-based polymer film, a vinyl alicyclic hydrocarbon polymer film, other appropriate plastic films, and laminated films thereof. Among these, the polyester film may be preferably used and the polyethylene terephthalate may be particularly preferably used from the viewpoint of readily obtaining the desired optical properties.

For the purpose of improving the interfacial adhesion between the above base and a layer provided on the base (such as the writing feel improving layer or a pressure sensitive adhesive layer to be described later), if desired, one surface or both surfaces of the base may be provided with an easy-adhesion layer formed by primer treatment or the like and/or a surface treatment layer formed by an oxidation method, a roughening method, or the like. Examples of the above oxidation method include corona discharge treatment, chromic acid treatment, flame treatment, hot-air treatment, and ozone/ultraviolet treatment. Examples of the above roughening method include a sandblast method and a solvent treatment method.

In the present specification, the above-described easy-adhesion layer and surface treatment layer are defined as being a part that constitutes the base. Accordingly, even when a writing feel improving sheet is assumed in which the writing feel improving layer is laminated directly on the base, for example, the possibility that the above-described easy-adhesion layer and/or surface treatment layer are present on the base of such a writing feel improving sheet is not excluded.

The thickness of the base may be preferably 20 μm or more, more preferably 80 μm or more, particularly preferably 100 μm or more, and further preferably 120 μm or more. When the lower limit of the thickness of the base falls within the above range, sufficient pencil hardness can be readily exhibited, and even in the case of providing one or more additional layers (e.g., a pressure sensitive adhesive layer) on the surface of the base opposite to the writing feel improving layer, such additional layers are less likely to affect the writing feel on the writing feel improving layer. From another aspect, the thickness of the base may be preferably 300 μm or less, more preferably 200 μm or less, and particularly preferably 150 μm or less. When the upper limit of the thickness of the base falls within the above range, the writing feel improving sheet according to the present embodiment can have moderate flexibility and the handling will be easy.

### (2) Writing Feel Improving Layer

The material for forming the above writing feel improving layer is not particularly limited, provided that it can achieve the dynamic friction coefficient for each of the previously described sliding speeds. The writing feel improving layer may be a hard coat layer having hard coat properties, and in this case the touch pen contact surface may readily have good scratch resistance.

The writing feel improving layer may be preferably formed by curing a coating composition, which will be described below. In particular, the coating composition may preferably contain a curable component and a surface conditioner.

### (2-1) Curable Component

The curable component may be a component that is cured by a trigger such as active energy rays or heat, and examples of the curable component include an active energy ray-curable component and a thermosetting component. In the present embodiment, it may be preferred to use the active energy ray-curable component from the viewpoint of the hardness of the writing feel improving layer formed, the heat resistance of the base (plastic film), and the like.

The active energy ray-curable component may preferably be a component that can be cured by irradiation with active energy rays to exhibit predetermined hardness and achieve the previously described physical properties.

Specific examples of the active energy ray-curable component include polyfunctional (meth)acrylate-based monomer, (meth)acrylate-based prepolymer, and active energy ray-curable polymer, among which the polyfunctional (meth)acrylate-based monomer and/or (meth)acrylate-based prepolymer may be preferred. The polyfunctional (meth)acrylate-based monomer and the (meth)acrylate-based prepolymer may each be used alone or both may also be used in combination. As used in the present specification, the (meth)acrylate refers to both an acrylate and a methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, pentaerythritol tetra(meth)acrylate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates. These may each be used alone or two or more types may also be used in combination.

On the other hand, examples of the (meth)acrylate-based prepolymer include urethane acrylate-based, polyester acrylate-based, epoxy acrylate-based, and polyol acrylate-based prepolymers. Among these, the urethane acrylate-based prepolymer may preferably be used from the viewpoint of readily achieving the dynamic friction coefficient for each of the previously described sliding speeds.

Examples of the urethane acrylate-based prepolymer include a reaction product generated by esterifying, with (meth)acrylic acid, a hydroxyl group of a polyurethane preoligomer that is obtained from polyether polyol or polyester polyol and polyisocyanate; and a reaction product generated by reacting a hydroxyl group-containing (meth)acrylic acid with a terminal isocyanate polyurethane oligomer that is obtained by the reaction between polyether polyol or polyester polyol and polyisocyanate.

### (2-2) Surface Conditioner

When the coating composition contains a surface conditioner, generation of streaky defects, unevenness, and the like can be suppressed in the writing feel improving layer formed. This allows the film thickness to be uniform, and the writing feel improving sheet can have a more excellent appearance and can readily have desired optical properties (such as the haze value and the total luminous transmittance). Moreover, the surface conditioner is readily exposed on the surface of the writing feel improving layer of the writing feel improving sheet; therefore, the slipperiness of the writing feel improving layer can be adjusted, and the dynamic friction coefficient for each of the previously described sliding speeds can readily be achieved.

Examples of the surface conditioner include fluorine-based, silicone-based, acrylic-based, and vinyl-based surface conditioners. Among these, at least one of the fluorine-based surface conditioner and the silicone-based surface conditioner may preferably be used from the viewpoint of easily adjusting the slipperiness of the writing feel improving layer. One type of the surface conditioner may be used alone or two or more types may also be used in combination.

Preferred examples of the fluorine-based surface conditioner include a compound having a perfluoroalkyl group or a fluorinated alkenyl group in the main chain or a side chain. Examples of commercially available products include, but are not limited to, BYK-340 available from BYK Japan KK., Ftergent 650A available from NEOS COMPANY LIMITED, Megafac RS-75 available from DIC, and V-8FM available from OSAKA ORGANIC CHEMICAL INDUSTRY LTD. The silicone-based surface conditioner may be preferably polydimethylsiloxane or modified polydimethylsiloxane and particularly preferably polydimethylsiloxane.

The content of the surface conditioner in the coating composition may be preferably 0.01 mass parts or more, particularly preferably 0.1 mass parts or more, and further preferably 0.2 mass parts or more with respect to 100 mass parts of the curable component. From another aspect, the content of the surface conditioner in the coating composition may be preferably 10 mass parts or less, more preferably 5 mass parts or less, particularly preferably 3 mass parts or less, and further preferably 1 mass part or less with respect to 100 mass parts of the curable component. When the content of the surface conditioner falls within the above range, the appearance of the writing feel improving sheet can be effectively improved. Moreover, the optical properties (such as the haze value and the total luminous transmittance) may easily be adjusted within the previously described range. Furthermore, the writing feel improving layer may readily achieve the dynamic friction coefficient for each of the previously described sliding speeds.

### (2-3) Fine Particles

When the coating composition contains fine particles, the surface of the writing feel improving layer formed can be a moderately rough surface; therefore, the haze value can easily be adjusted and the desired antiglare properties can readily be exhibited.

The above fine particles refer to those having a larger average particle diameter than that of silica nanoparticles, which will be described later. For example, the average particle diameter of the above fine particles may be preferably 1 μm or more, particularly preferably 2 μm or more, and further preferably 3 μm or more. From another aspect, the average particle diameter of the above fine particles may be preferably 20 μm or less, particularly preferably 14 μm or less, and further preferably 8 μm or less. When the average particle diameter of the above fine particles falls within the above range, the haze value can be more easily adjusted.

The coefficient of variation (CV value) of the particle diameter of the above fine particles represented by the following equation may be preferably 3% or more and particularly preferably 8% or more. From another aspect, the coefficient of variation (CV value) of the particle diameter may be preferably 70% or less, particularly preferably 45% or less, and further preferably 25% or less. When the CV value of the above fine particles falls within the above range, the roughened shape of the surface may easily be adjusted; therefore, the dynamic friction coefficient for each of the previously described sliding speeds can readily be achieved, and the haze value can be more easily adjusted.

Coefficient of variation (CV value) of particle diameter=(Standard deviation particle diameter/Average particle diameter)×100

The above-described average particle diameter and coefficient of variation (CV value) of the fine particles refer to values measured with a laser diffraction and scattering-type particle diameter distribution measurement device using a few drops of a dispersion liquid as a sample. The dispersion liquid may be prepared with methyl ethyl ketone as a dispersion medium and may have a concentration of 5 mass %.

The above fine particles may be organic fine particles, inorganic fine particles, or resin fine particles having both inorganic and organic properties. From the viewpoint of readily achieving the dynamic friction coefficient for each of the previously described sliding speeds and easily adjusting the haze value, the fine particles may preferably be organic fine particles or resin fine particles having both inorganic and organic properties.

Examples of the organic fine particles include acrylic-based resin fine particles (such as polymethylmethacrylate fine particles), silicone-based fine particles, melamine-based resin fine particles, acrylic-styrene-based copolymer fine particles, polycarbonate-based fine particles, polyethylene-based fine particles, polystyrene-based fine particles, and benzoguanamine-based resin fine particles. These resins may be crosslinked. Among the above, the acrylic-based resin fine particles and the silicone-based fine particles may be preferred from the viewpoint of more easily adjusting the haze value.

Examples of the inorganic fine particles include fine particles composed of silica, alumina, titania, zirconia, tin oxide, indium oxide, cadmium oxide, antimony oxide, and the like.

Particularly preferred resin fine particles having both the inorganic and organic properties may be silicone fine particles (e.g., Tospearl series available from Momentive Performance Materials Japan).

One type of the above fine particles may be used alone or two or more types may also be used in combination.

The above fine particles may be subjected to a desired surface modification. The shape of the fine particles may be a finite shape such as a spherical shape or may also be an indefinite shape in which the shape is not specified. From the viewpoint of readily achieving the dynamic friction coefficient for each of the previously described sliding speeds and more easily adjusting the haze value, the shape of the fine particles may be preferably a definite shape and particularly preferably a spherical shape.

The content of the fine particles in the coating composition may be preferably 0.01 mass parts or more, more preferably 0.1 mass parts or more, particularly preferably 1 mass part or more, and further preferably 3 mass parts or more with respect to 100 mass parts of the curable component. From another aspect, the content of the fine particles in the coating composition may be preferably 50 mass parts or less, particularly preferably 30 mass parts or less, and further preferably 10 mass parts or less with respect to 100 mass parts of the curable component. When the content of the fine particles falls within the above range, the dynamic friction coefficient for each of the previously described sliding speeds can readily be achieved while exhibiting the antiglare properties.

### (2-4) Other Components

The coating composition in the present embodiment may contain various additives in addition to the above components. Examples of such additives include a photopolymerization initiator, silica nanoparticles, an ultraviolet absorber, an antioxidant, a light stabilizer, an antistatic, a silane coupling agent, an antiaging agent, a thermal polymerization inhibitor, a colorant, a surfactant, a storage stabilizer, a plasticizer, a glidant, an antifoam, an organic-based filler, a wettability improving agent, and a coating surface improving agent.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, and p-dimethylaminobenzoic ester. These may each be used alone or two or more types may also be used in combination.

The content of the photopolymerization initiator in the coating composition may be preferably 1 mass part or more and particularly preferably 2 mass parts or more with respect to 100 mass parts of the curable component. From another aspect, the content of the photopolymerization initiator in the coating composition may be preferably 10 mass parts or less and particularly preferably 5 mass parts or less with respect to 100 mass parts of the curable component.

### (2-5) Thickness

The thickness of the writing feel improving layer may be preferably 0.1 μm or more, particularly preferably 1 μm or more, and further preferably 2 μm or more. From another aspect, the thickness of the writing feel improving layer may be preferably 30 μm or less, more preferably 20 μm or less, and particularly preferably 10 μm or less. When the thickness of the writing feel improving layer falls within the above range, the writing feel improving sheet according to the present embodiment can readily achieve the dynamic friction coefficient for each of the previously described sliding speeds.

### (3) Other Members

The writing feel improving sheet according to the present embodiment may further have one or more other layers, provided that the writing feel improving layer is exposed at the outermost surface. For example, a pressure sensitive adhesive layer may be formed on the surface of the base opposite to the writing feel improving layer and a release sheet may be further laminated on the pressure sensitive adhesive layer.

A product usually used for optical application can be used as a pressure sensitive adhesive that constitutes the pressure sensitive adhesive layer, and examples thereof include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. Among these, the acrylic-based pressure sensitive adhesive may be preferred because it exhibits desired pressure sensitive adhesive properties and is excellent in the optical properties and durability.

The thickness of the pressure sensitive adhesive layer may be preferably 5 μm or more, particularly preferably 10 μm or more, and further preferably 20 μm or more. From another aspect, the thickness of the pressure sensitive adhesive layer may be preferably 300 μm or less, more preferably 100 μm or less, and particularly preferably 50 μm or less.

Examples of the release sheet for use include a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene-vinyl acetate film, an ionomer resin film, an ethylene-(meth)acrylic acid copolymer film, an ethylene-(meth)acrylic ester copolymer film, a polystyrene film, a polycarbonate film, a polyimide film, a fluorine resin film, and a liquid crystal polymer film. Crosslinked films thereof may also be used. A laminate film obtained by laminating a plurality of such films may also be used.

It may be preferred to perform release treatment for the release surface (surface to be in contact with the pressure sensitive adhesive layer) of the release sheet. Examples of a release agent to be used for the release treatment include alkyd-based, silicone-based, fluorine-based, unsaturated polyester-based, polyolefin-based, and wax-based release agents.

The thickness of the release sheet is not particularly limited, but may ordinarily be about 20 to 150 μm.

### 3. Production Method for Writing Feel Improving Sheet

The production method for the writing feel improving sheet according to the present embodiment is not particularly limited, provided that the writing feel improving sheet can achieve the dynamic friction coefficient for each of the previously described sliding speeds. For example, it may be preferred to produce the writing feel improving sheet through coating the base with a coating liquid that contains the previously described coating composition and, if desired, a solvent and curing the obtained coating film to form the writing feel improving layer.

The solvent can be used for improvement of coating properties, adjustment of viscosity, adjustment of solid content concentration, and the like. Such a solvent can be used without particular limitation, provided that it dissolves curable components and the like and disperses fine particles and the like.

Specific examples of the solvent include alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and γ-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as dimethylformamide, dimethylacetamide, and N-methylpyrrolidone.

The coating with the coating liquid of the coating composition may be performed using an ordinary method, such as a bar coating method, a knife coating method, a roll coating method, a blade coating method, a die coating method, or a gravure coating method. After the coating with the coating liquid of the coating composition, it may be preferred to dry the coating film at 40° C. to 120° C. for about 30 seconds to 5 minutes.

When the coating composition has active energy ray curability, the coating composition may be cured by irradiating the coating film of the coating composition with active energy rays such as ultraviolet rays and electron rays. Irradiation with ultraviolet rays can be performed using a high-pressure mercury lamp, a fusion H lamp, a xenon lamp, or the like, and the irradiance level of ultraviolet rays may be preferably about 50 to 1,000 mW/cm² as the illuminance and about 50 to 1,000 mJ/cm² as the light amount and particularly preferably about 100 to 500 mW/cm² as the illuminance and about 100 to 500 mJ/cm² as the light amount. On the other hand, irradiation with electron rays can be performed using an electron ray accelerator or the like, and the irradiance level of electron rays may be preferably about 10 to 1,000 krad.

### 4. Use of Writing Feel Improving Sheet

The writing feel improving sheet according to the present embodiment can be used as a sheet that constitutes the outermost layer of a touch panel (image display device with position detection function) on which a touch pen is used. Specifically, the writing feel improving sheet may preferably be used by being laminated on the cover material of a display body module such as a liquid crystal (LCD) module, a light emitting diode (LED) module, or an organic electroluminescence (organic EL) module or the cover material of a touch panel having a touch sensor or the like. Lamination of the writing feel improving sheet on the cover material may preferably be performed by attaching the writing feel improving sheet to the cover material via the previously described pressure sensitive adhesive layer.

The touch pen used for the writing feel improving sheet according to the present embodiment is not particularly limited, and a conventionally known one can be used. As the touch pen, for example, a touch pen having a polyacetal pen tip, a touch pen having a hard felt pen tip, a touch pen having an elastomer pen tip, or the like can be used. Among these, a touch pen having an elastomer pen tip may preferably be used from the viewpoint of readily satisfying the dynamic friction coefficient for each of the previously described sliding speeds.

The shape of the pen tip of a touch pen used for the writing feel improving sheet according to the present embodiment is not particularly limited, and can be appropriately selected from a disk shape, a circular shape, a polygonal shape, and the like, but from the viewpoint that the feeling of vibration when writing with a ballpoint pen can be obtained, a circular shape may be preferred. When the shape of the pen tip of a touch pen is a circular shape, the diameter of the pen tip may be preferably 0.1 mm or more, particularly preferably 0.2 mm or more, and further preferably 0.3 mm or more. From another aspect, the above diameter may be preferably 5 mm or less, particularly preferably 2 mm or less, and further preferably 1 mm or less.

The writing feel improving sheet according to the present embodiment satisfies the dynamic friction coefficient for each of the previously described sliding speeds and can thereby well reproduce the feeling of vibration from a pen or pencil (in particular, a ballpoint pen) when writing on paper with the pen or pencil. This allows the writing feel when writing on paper with a pen or pencil to be reproduced well.

### 5. Another Embodiment

The above-described writing feel improving sheet according to the present embodiment may constitute another embodiment of the present invention together with one or more other elements.

For example, another embodiment of the present invention may be a set of the above-described writing feel improving sheet and a touch pen used for the writing feel improving sheet. Examples of the touch pen used in the set include a touch pen having a polyacetal pen tip, a touch pen having a hard felt pen tip, a touch pen having an elastomer pen tip, and other similar touch pens. Among these, a touch pen having an elastomer pen tip may preferably be used from the viewpoint of readily achieving excellent writing feel.

Still another embodiment of the present invention may be an image display device (in particular, a touch panel) including the above-described writing feel improving sheet on the outermost surface.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

For example, one or more other layers may be interposed between the base and the writing feel improving layer in the writing feel improving sheet according to the present embodiment.

### EXAMPLES

Hereinafter, the present invention will be described further specifically with reference to examples etc., but the scope of the present invention is not limited to these examples etc.

### Preparation Examples

The materials listed in Table 1 were mixed at the compositions listed in Table 2 to obtain coating compositions C1 to C7. The compounding ratios listed in Table 2 are ratios based on the solid content equivalents. The obtained coating compositions were diluted with propylene glycol monomethyl ether to obtain coating liquids of the coating compositions C1 to C7.

### Example 1

### (1) Formation of Writing Feel Improving Layer

One surface of a polyethylene terephthalate (PET) film having easy-adhesion layers on both surfaces (available from Toray Industries, Inc., product name “Lumirror U48,” thickness: 125 μm) as the base was coated with the coating liquid of the coating composition C1 obtained in the above-described preparation examples using a Meyer bar to obtain a coating film and the coating film was then dried by heating at 70° C. for 1 minute using an oven.

Then, under a nitrogen atmosphere, the above coating film was cured by being irradiated with ultraviolet rays under the following condition using an ultraviolet irradiation apparatus (available from GS Yuasa Corporation, product name “Nitrogen purge small conveyer-type UV irradiation apparatus CSN2-40”) to form a writing feel improving layer having a thickness of 10 μm.

### <Ultraviolet Irradiation Condition>

Light source: High-pressure mercury lamp
Lamp power: 1.4 kW
Conveyor speed: 1.2 m/min
Illuminance: 100 mW/cm²
Light amount: 240 mJ/cm²
Oxygen concentration: 1% or less

### (2) Formation of Pressure Sensitive Adhesive Layer

A (meth)acrylic ester copolymer was prepared by copolymerizing 95 mass parts of n-butyl acrylate and 5 mass parts of acrylic acid using a solution polymerization method. When the molecular weight of the (meth)acrylic ester copolymer was measured by the method described later, the weight-average molecular weight (Mw) was 1,500,000.

The coating liquid of a pressure sensitive adhesive composition was obtained through mixing and sufficiently stirring 99.8 mass parts (solid content equivalent; here and hereinafter) of the (meth)acrylic ester copolymer obtained as above and 0.2 mass parts of 1,3-bis(N,N-diglycidylaminomethyl)cyclohexane as the crosslinker and diluting them with toluene.

Subsequently, the release surface of a release sheet (available from LINTEC Corporation, product name “SP-PET381031”) in which a silicone-based release agent layer was formed on one surface of a polyethylene terephthalate film having a thickness of 38 μm was coated with the coating liquid of the pressure sensitive adhesive composition obtained as above using an applicator to form a coating film. The coating film was dried by heating at 100° C. for 3 minutes using an oven and aged under a condition of 23° C. and 50% RH for 7 days, and a pressure sensitive adhesive layer having a thickness of 25 μm was formed on the release sheet.

Here, the above-described weight-average molecular weight (Mw) refers to a weight-average molecular weight that is measured as a polystyrene equivalent value under the following condition using gel permeation chromatography (GPC) (GPC measurement).

### <Measurement Condition>

GPC measurement apparatus: HLC-8320 available from Tosoh Corporation
GPC columns (passing through in the following order): available from Tosoh Corporation

TSK gel super H-H
TSK gel super HM-H
TSK gel super H2000

Solvent for measurement: tetrahydrofuran
Measurement temperature: 40° C.

### (3) Formation of Writing Feel Improving Sheet

The surface on the base side of the laminate of the base and writing feel improving layer obtained in the above-described step (1) and the surface on the pressure sensitive adhesive layer side of the laminate of the release sheet and pressure sensitive adhesive layer obtained in the above-described step (2) were attached to each other thereby to obtain a writing feel improving sheet in which the writing feel improving layer, the base, the pressure sensitive adhesive layer, and the release sheet were laminated in this order.

### Examples 2 to 5 and Comparative Examples 1 and 2

Writing feel improving sheets were produced in the same manner as in Example 1 except that the type of the coating composition used and the thickness of the writing feel improving layer were as listed in Table 3.

### <Testing Example 1> (Measurement of Optical Properties)

The release sheet was removed from the writing feel improving sheet produced in each of Examples and Comparative Examples, the exposed surface (pressure sensitive adhesive surface) of the exposed pressure sensitive adhesive layer was attached to a glass plate (thickness: 1.2 mm), and this was used as a sample for measurement.

Then, after performing the background measurement on the glass plate alone, a haze meter (available from NIPPON DENSHOKU INDUSTRIES CO., LTD., product name “NDH-5000”) was used for the above sample for measurement to measure the haze value (%) of the writing feel improving sheet in accordance with JIS K7136:2000 and measure the total luminous transmittance (%) of the writing feel improving sheet in accordance with JIS Z8741:1997. These results are listed in Table 3.

### <Testing Example 2> (Measurement of Pencil Hardness)

The release sheet was removed from the writing feel improving sheet produced in each of Examples and Comparative Examples, the exposed surface (pressure sensitive adhesive surface) of the exposed pressure sensitive adhesive layer was attached to a glass plate (thickness: 1.2 mm), and this was used as a sample for measurement.

For the surface on the writing feel improving layer side (touch pen contact surface) of the above sample for measurement, the scratch hardness was measured by the pencil method in accordance with JIS K5600-5-4:1999 under a condition of a load of 750 g and a speed of 1.0 mm/s using a pencil scratch coating hardness tester (available from Toyo Seiki Seisaku-sho, Ltd., product name “NP”). The results are listed in Table 3.

### <Testing Example 3> (Evaluation of Scratch Resistance)

The release sheet was removed from the writing feel improving sheet produced in each of Examples and Comparative Examples, the exposed surface (pressure sensitive adhesive surface) of the exposed pressure sensitive adhesive layer was attached to a glass plate (thickness: 1.2 mm), and this was used as a sample for measurement.

The surface on the writing feel improving layer side (touch pen contact surface) of the above sample for measurement was rubbed at a load of 125 g/cm² using #0000 steel wool to reciprocate it ten times within a length of 10 cm. The surface of the writing feel improving layer was visually confirmed under a three-wavelength fluorescent lamp, and the scratch resistance was evaluated in accordance with the following criteria. The results are listed in Table 3.

A: No scratches were confirmed.

B: 10 or less scratches were confirmed.

C: 11 or more scratches were confirmed.

### <Testing Example 4> (Friction Measurement)

The release sheet was removed from the writing feel improving sheet produced in each of Examples and Comparative Examples, the exposed surface (pressure sensitive adhesive surface) of the exposed pressure sensitive adhesive layer was attached to a glass plate (thickness: 1.2 mm), and this was used as a sample for measurement.

The above sample for measurement was set on a dedicated carriage for measurement of a static and dynamic friction tester (available from Trinity-Lab Inc., product name “Tribomaster TL201 Ts”) so that the surface on the writing feel improving layer side (touch pen contact surface) was on the upper side. The above dedicated carriage for measurement is configured to reciprocally move in a predetermined direction while keeping the setting surface of the above sample for measurement horizontal as the above static and dynamic friction tester is used.

Subsequently, a touch pen (touch pen for testing) was fixed to the above static and dynamic friction tester so that the pen tip came into contact with the touch pen contact surface. At that time, the touch pen was inclined and fixed so that the angle formed between the touch pen and the touch pen contact surface was 45°. In addition, the tilting direction at that time was inclined toward the traveling direction side of the dedicated carriage for measurement and parallel to the traveling direction. The above touch pen used was a touch pen having an elastomer pen tip (available from Wacom Co., Ltd., product name “ACK-20004,” pen tip diameter: 0.5 mm).

Subsequently, in a state in which a load was applied to the touch pen under a pressurization condition of the load of 200 g, the above-described dedicated carriage for measurement was moved at four speeds (sliding speeds) of 1.5 mm/s, 20 mm/s, 50 mm/s, and 80 mm/s thereby to slide the touch pen on the touch pen contact surface (sliding distance: 100 mm), and the dynamic friction coefficient was calculated for each sliding speed on the basis of the friction force measured during the movement. These results are listed in Table 3.

As a reference, the dynamic friction coefficient when writing on paper with a pen or pencil was also measured as in the above manner. Specifically, in a state in which 20 sheets of commercially available papers (available from KOKUYO Co., Ltd., product name “Campus Loose Leaf SHIKKARIKAKERU,” product model number “NO-S836BT,” size: B5, ruled width: B-ruled) were stacked, these sheets of papers were set on the dedicated carriage for measurement of the above static and dynamic friction tester, and a pen or pencil was then fixed to the above static and dynamic friction tester so that the pen tip came into contact with the outermost surface of the stacked sheets of papers. Pens and pencil used herein are a ballpoint pen A (available from BIC, product name “Orange EG 0.7,” oil-based ballpoint pen, pen tip diameter: 0.7 mm), a ballpoint pen B (available from BIC, product name “Orange EG 1.0,” oil-based ballpoint pen, pen tip diameter: 1.0 mm), and a pencil (available from MITSUBISHI PENCIL CO., LTD., product name “Mitsubishi Pencil Uni B,” hardness of pencil lead: B). Then, the pen or pencil was slid on the surface of the paper at the above-described four sliding speeds, and the dynamic friction coefficient was calculated for each sliding speed on the basis of the friction force measured during the movement. These results are also listed in Table 3.

Furthermore, for each of the Examples, Comparative Examples, and Reference Examples obtained as described above, the dynamic friction coefficients for respective four sliding speeds were plotted on a coordinate plane with the sliding speed as the horizontal axis (X-axis) (unit: mm/s) and the dynamic friction coefficient as the vertical axis (Y-axis).

Then, calculations on the above coordinate plane were performed for the inclination of a line segment connecting between coordinates at which the sliding speed was 1.5 mm/s and coordinates at which the sliding speed was 20 mm/s (in Table 3, indicated as Inclination “vs. 20 mm/s”), the inclination of a line segment connecting between coordinates at which the sliding speed was 1.5 mm/s and coordinates at which the sliding speed was 50 mm/s (in Table 3, indicated as Inclination “vs. 50 mm/s”), the intercept of the line segment connecting between coordinates at which the sliding speed was 1.5 mm/s and coordinates at which the sliding speed was 50 mm/s (in Table 3, indicated as Intercept “vs. 50 mm/s”), and the inclination of a line segment connecting between coordinates at which the sliding speed was 1.5 mm/s and coordinates at which the sliding speed was 80 mm/s (in Table 3, indicated as Inclination “vs. 80 mm/s”). These results are also listed in Table 3.

In addition, the expression of an approximation curve was obtained on the above coordinate plane by performing polynomial approximation of four sets of coordinates: coordinates at which the sliding speed was 1.5 mm/s; coordinates at which the sliding speed was 20 mm/s; coordinates at which the sliding speed was 50 mm/s; and coordinates at which the sliding speed was 80 mm/s. When the expression is represented by the following expression (1):

Y=aX²+bX+c (1),

the values of coefficients “a,” “b,” and “c” are listed in Table 3.

### <Testing Example 5> (Evaluation of Writing Feel)

The release sheet was removed from the writing feel improving sheet produced in each of Examples and Comparative Examples, the exposed surface (pressure sensitive adhesive surface) of the exposed pressure sensitive adhesive layer was attached to a glass plate (thickness: 1.2 mm), and this was used as a sample for measurement.

For the surface on the writing feel improving layer side (touch pen contact surface) of the above sample for measurement, an evaluator evaluated the writing feel on the basis of the following criteria through a predetermined writing operation in a simulated manner using the same touch pen used in the friction measurement of Testing Example 3. The results are listed in Table 3.

A: Excellent writing feel was obtained.

B: Although not as “excellent writing feel,” good writing feel within allowable range was obtained.

C: Writing feel was poor.

TABLE 1

| Name of material | Symbol | Details of material |
|---|---|---|
| Curable component | a | Pentaerythritol triacrylate |
| | b | Polyfunctional urethane acrylate |
| | | (available from |
| | | ARAKAWA CHEMICAL INDUSTRIES, LTD., |
| | | product name “Beamset 575C8”) |
| Surface conditioner | c | Reactive fluorine-based oligomer |
| | d | Polyester-modified polydimethylsiloxane |
| Fine particles | e | Material: Silicone, Shape: spherical, |
| | | Average particle diameter: 4.5 μm, |
| | | Coefficient of variation of particle diameter: 24% |
| Photopolymerization initiator | f | α-hydroxy phenyl ketone |

TABLE 2

| | Composition of coating composition | | | | |
|---|---|---|---|---|---|
| Coating | Curable | Surface | Fine | Photopolymerization | Compounding |
| composition | component | conditioner | particles | initiator | ratio (mass parts) |
| C1 | a | c | — | f | a/c/f = 100/1/3 |
| C2 | a | d | — | f | a/d/f = 100/1/3 |
| C3 | b | c | e | f | b/c/e/f = 100/0.25/4.5/3 |
| C4 | a | c | — | f | a/c/f = 100/3/3 |
| C5 | a | c | — | f | a/c/f = 100/0.2/3 |
| C6 | a | — | — | f | a/f = 100/3 |
| C7 | a | d | — | f | a/d/f = 100/5/3 |

TABLE 3

| | | | | | | | | | Comparative |
|---|---|---|---|---|---|---|---|---|---|
| | | | | Example 1 | Example 2 | Example 3 | Example 4 | Example 5 | Example 1 |
| Writing feel | Type of coating | | | C1 | C2 | C3 | C4 | C5 | C6 |
| improving | composition | | | | | | | | |
| layer | Thickness (μm) | | | 3 | 5 | 3 | 3 | 3 | 3 |
| Optical | Haze value (%) | | | 0.6 | 0.6 | 15.3 | 0.7 | 0.6 | 0.6 |
| properties | Total luminous | | | 90.4 | 90.4 | 90.1 | 90.1 | 90.2 | 90.4 |
| | transmittance (%) | | | | | | | | |
| Pencil hardness | | | | 2H or higher | 2H or higher | 2H or higher | 2H or higher | 2H or higher | 2H or higher |
| Evaluation of scratch resistance | | | | A | A | A | A | A | A |
| Dynamic | Sliding | 1.5 | mm/s | 0.26 | 0.22 | 0.28 | 0.15 | 0.31 | 0.26 |
| friction | speed | 20 | mm/s | 0.30 | 0.29 | 0.32 | 0.18 | 0.38 | 0.43 |
| coefficient | | 50 | mm/s | 0.33 | 0.31 | 0.35 | 0.21 | 0.43 | 0.61 |
| | | 80 | mm/s | 0.33 | 0.32 | 0.35 | 0.21 | 0.45 | 0.61 |

| | | | | | | | |
|---|---|---|---|---|---|---|---|
| Inclination | vs. 20 mm/s | 0.0022 | 0.0038 | 0.0022 | 0.0016 | 0.0038 | 0.0092 |
| | vs. 50 mm/s | 0.0014 | 0.0019 | 0.0014 | 0.0012 | 0.0025 | 0.0072 |
| | vs. 80 mm/s | 0.0009 | 0.0013 | 0.0009 | 0.0008 | 0.0018 | 0.0045 |
| Intercept | vs. 50 mm/s | 0.2578 | 0.2172 | 0.2778 | 0.1481 | 0.3063 | 0.2492 |

| | | | | | | | |
|---|---|---|---|---|---|---|---|
| Coefficient of | a | −2 × 10⁻⁵ | −3 × 10⁻⁵ | −2 × 10⁻⁵ | −2 × 10⁻⁵ | −3 × 10⁻⁵ | −9 × 10⁻⁵ |
| expression of | b | 0.0024 | 0.0033 | 0.0024 | 0.0020 | 0.0039 | 0.0117 |
| approximation curve | c | 0.2572 | 0.2215 | 0.2772 | 0.1466 | 0.3072 | 0.2390 |

| | | | | | | |
|---|---|---|---|---|---|---|
| Evaluation of writing feel | A | A | A | B | B | C |

| | | | | Comparative | Reference | Reference | Reference |
|---|---|---|---|---|---|---|---|
| | | | | Example 2 | Example 1 | Example 2 | Example 3 |
| Writing feel | Type of coating | | | C7 | Writing on | Writing on | Writing on |
| improving | composition | | | | paper with | paper with | paper with |
| layer | Thickness (μm) | | | 5 | ballpoint | ballpoint | pencil |
| Optical | Haze value (%) | | | 0.6 | pen A | pen B | |
| properties | Total luminous | | | 90.2 | | | |
| | transmittance (%) | | | | | | |
| Pencil hardness | | | | 2H or higher | | | |
| Evaluation of scratch resistance | | | | A | | | |
| Dynamic | Sliding | 1.5 | mm/s | 0.12 | 0.27 | 0.24 | 0.24 |
| friction | speed | 20 | mm/s | 0.14 | 0.32 | 0.27 | 0.24 |
| coefficient | | 50 | mm/s | 0.15 | 0.33 | 0.30 | 0.23 |
| | | 80 | mm/s | 0.15 | 0.34 | 0.30 | 0.23 |

| | | | | | |
|---|---|---|---|---|---|
| Inclination | vs. 20 mm/s | 0.0011 | 0.0027 | 0.0016 | 0.0000 |
| | vs. 50 mm/s | 0.0006 | 0.0012 | 0.0012 | −0.0002 |
| | vs. 80 mm/s | 0.0004 | 0.0009 | 0.0008 | −0.0001 |
| Intercept | vs. 50 mm/s | 0.1191 | 0.2681 | 0.2381 | 0.2403 |

| | | | | | |
|---|---|---|---|---|---|
| Coefficient of | a | −9 × 10⁻⁶ | −2 × 10⁻⁵ | −2 × 10⁻⁵ | 1 × 10⁻⁸ |
| expression of | b | 0.0011 | 0.0022 | 0.0020 | −0.0003 |
| approximation curve | c | 0.1194 | 0.2720 | 0.2366 | 0.2417 |

| | | | | |
|---|---|---|---|---|
| Evaluation of writing feel | C | — | — | — |

As apparent from Table 3, the writing feel improving sheets produced in Examples can well reproduce the writing feel when writing on paper with a pen or pencil, and excellent writing feel can be achieved. Moreover, for the writing feel improving sheets produced in Examples, good results are also obtained in the evaluation of various optical properties.

### INDUSTRIAL APPLICABILITY

The writing feel improving sheet of the present invention may be preferably used as the outermost layer of a touch panel on which a touch pen is used.

1. A writing feel improving sheet having a touch pen contact surface with which a touch pen comes into contact,
the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein
the dynamic friction coefficient when the sliding speed is 1.5 mm/s is 0.13 or more and 0.35 or less,
the dynamic friction coefficient when the sliding speed is 20 mm/s is 0.15 or more and 0.40 or less,
the dynamic friction coefficient when the sliding speed is 50 mm/s is 0.18 or more and 0.45 or less, and
the dynamic friction coefficient when the sliding speed is 80 mm/s is 0.18 or more and 0.47 or less.

2. A writing feel improving sheet having a touch pen contact surface with which a touch pen comes into contact,
the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein
when measurement results are plotted on a coordinate plane with the sliding speed as a horizontal axis (unit: mm/s) and the dynamic friction coefficient as a vertical axis,
an inclination of a line segment connecting between coordinates at which the sliding speed is 1.5 mm/s and coordinates at which the sliding speed is 50 mm/s is more than 0.0006 and less than 0.0072.

3. A writing feel improving sheet having a touch pen contact surface with which a touch pen comes into contact,
the writing feel improving sheet having a dynamic friction coefficient as measured when, after a pen tip of a touch pen is brought into contact with the touch pen contact surface, a load of 200 g is applied to the touch pen and the touch pen is linearly slid at a predetermined sliding speed while maintaining an angle formed between the touch pen and the touch pen contact surface at 45°, the pen tip having a diameter of 0.5 mm, wherein
when measurement results are plotted on a coordinate plane with the sliding speed as a horizontal axis (X-axis) (unit: mm/s) and the dynamic friction coefficient as a vertical axis (Y-axis),
an approximation curve obtained by polynomial approximation of four sets of coordinates: coordinates at which the sliding speed is 1.5 mm/s; coordinates at which the sliding speed is 20 mm/s; coordinates at which the sliding speed is 50 mm/s; and coordinates at which the sliding speed is 80 mm/s satisfies following expressions (1) to (4):
Y=aX²+bX+c (1),
−5×10⁻⁵≤a≤−5×10⁻⁶ (2),
0.0001≤b≤0.008 (3), and
0.11≤c≤0.31 (4).

4. The writing feel improving sheet according to claim 1, comprising:
a writing feel improving layer; and
a base provided on one surface side of the writing feel improving layer,
wherein the touch pen contact surface is a surface of the writing feel improving layer opposite to the base.

5. The writing feel improving sheet according to claim 2, comprising:
a writing feel improving layer; and
a base provided on one surface side of the writing feel improving layer,
wherein the touch pen contact surface is a surface of the writing feel improving layer opposite to the base.

6. The writing feel improving sheet according to claim 3, comprising:
a writing feel improving layer; and
a base provided on one surface side of the writing feel improving layer,
wherein the touch pen contact surface is a surface of the writing feel improving layer opposite to the base.
